(19) United States
(12) Patent Application Publication
(10) Pub. No.: US 2015/0005942 A1
(43) Pub. Date: Jan. 1, 2015

(54) PORTABLE OPERATION PANEL HAVING VIBRATION MOTOR

(71) Applicant: FANUC CORPORATION, Yamanashi (JP)

(72) Inventor: Ryoutarou Inaba, Yamanashi (JP)

(73) Assignee: FANUC CORPORATION, Yamanashi (JP)

(21) Appl. No.: 14/313,463

(22) Filed: Jun. 24, 2014

(30) Foreign Application Priority Data
Jun. 27, 2013 (JP) 2013-134724
Jun. 4, 2014 (JP) 2014-116136

(51) Int. Cl. B25J 13/02

(52) U.S. Cl. CPC B25J 13/025; Y10S 901/02
USPC 700/264; 901/2

(57) ABSTRACT

A portable operation panel having a vibration motor capable of tactually providing an operator information, wherein a problem due to failure of the vibration motor is solved. An operation panel has a controlling part, a plurality of vibration motors and an inputting part to which an operator can input information, wherein the controlling part controls the behaviors of the operation panel based on the information input into the inputting part. When the vibration motors are operated based on a command from the controlling part, the operation panel at least partially vibrates due to the motion of the vibration motor, whereby the operator tactually feels the vibration. When the operator inputs information into the inputting part for switching the vibration motor while the first vibration motor is in use, a vibration motor to be used is switched from the first vibration motor to the second vibration motor.

### BACKGROUND OF THE INVENTION

1. Field of the Invention

The present invention relates to a portable operation panel which is used in association with a controller of a machine such as a robot.

2. Description of the Related Art

When a machine such as a robot is taught or operated, a portable operation panel may be used in association with a robot controller of the robot. For example, JP 2006-341356 A discloses a portable operation panel connected to a robot controller via a cable.

For example, an operator teaches a robot, the operator may operate the portable operation panel while watching the robot, i.e., without watching an indicator such as a display of the portable operation panel. Further, when the portable operation panel is used in loud environments, it is difficult to aurally provide the operator information from the portable operation panel. Therefore, in an environment in which the portable operation panel is used, it is often difficult to visually or aurally provide the operator information from the portable operation panel.

One effective measure for solving the above problem is to provide the portable operation panel with a vibration motor so that information is tactually provided to the operator by vibrating the panel. However, from a structural point of view, the life of the vibration motor adapted to be provided to the portable operation panel is short relative to a life required for another device provided to an industrial robot or a machine. Therefore, in the prior art, the vibration motor can no longer be used during use of the portable operation panel, whereby the operation of the portable operation panel is interrupted and work efficiency is reduced.

### SUMMARY OF THE INVENTION

Thus, the object of the present invention is to provide a portable operation panel having a vibration motor capable of tactually providing an operator information, wherein a problem due to failure of the vibration motor is solved.

The present invention provides a portable operation panel connected to a controller for controlling a machine so that the portable operation panel is used to operate the machine, the portable operation panel comprising: a plurality of vibration motors which generate vibration for providing predetermined information to an operator; and a switching part which switches a motor to be used from a first vibration motor of the plurality of vibration motors to a second vibration motor of the plurality of vibration motors.

In a preferred embodiment, the portable operation panel comprises an inputting part to which the operator can input information, wherein the switching part switches the motor to be used from the first vibration motor to the second vibration motor based on the information which is input to the inputting part.

In a preferred embodiment, the portable operation panel comprises a sensor which detects a malfunction of the vibration motor, non-vibration of the portable operation panel or weakening of the vibration of the portable operation panel, wherein the switching part automatically switches the motor to be used from the first vibration motor to the second vibration motor when the sensor detects the malfunction of the vibration motor, the non-vibration of the portable operation panel or the weakening of the vibration of the portable operation panel.

In a preferred embodiment, the portable operation panel comprises a time measuring part which measures an accumulated operating time of the vibration motor, wherein the switching part automatically switches the motor to be used from the first vibration motor to the second vibration motor when the accumulated operating time of the vibration motor during use reaches a predetermined time limit of use.

In a preferred embodiment, the portable operation panel comprises a connector arranged on a control board incorporated into the portable operation panel, wherein at least one of the plurality of vibration motors is detachably connected to the connector.

When the portable operation panel comprises the inputting part, the portable operation panel may further comprise a displaying part which displays the information which is input to the inputting part.

When the portable operation panel comprises the sensor, the portable operation panel may further comprise a displaying part which displays a detection result of the sensor or information obtained by the detection result.

When the portable operation panel comprises the time measuring part, the portable operation panel may further comprise a displaying part which displays the accumulated operating time of each vibration motor measured by the time measuring part.

When the portable operation panel comprises the inputting part, the portable operation panel may further comprise: a sensor which detects a malfunction of the vibration motor, non-vibration of the portable operation panel or weakening of the vibration of the portable operation panel; and a displaying part which displays a detection result of the sensor or information obtained by the detection result.

When the portable operation panel comprises the inputting part, the portable operation panel may further comprise: a time measuring part which measures an accumulated operating time of the vibration motor; and a displaying part which displays the accumulated operating time of each vibration motor measured by the time measuring part.

### BRIEF DESCRIPTION OF THE DRAWINGS

The above and other objects, features and advantages of the present invention will be made more apparent by the following description of the preferred embodiments thereof, with reference to the accompanying drawings, wherein:

FIG. 1 shows a schematic configuration of a portable operation panel according to a first embodiment of the present invention;

FIG. 2 shows a schematic configuration of a portable operation panel according to a second embodiment of the present invention;

FIG. 3 shows a schematic configuration of a portable operation panel according to a third embodiment of the present invention;

FIG. 4 shows an example wherein a detachable connector is provided to the portable operation panel;

FIG. 5 shows an example wherein a displaying part is provided to the portable operation panel of the first embodiment;

FIG. 6 shows an example wherein a displaying part is provided to the portable operation panel of the second embodiment; and

FIG. 7 shows an example wherein a displaying part is provided to the portable operation panel of the third embodiment.

### DETAILED DESCRIPTION

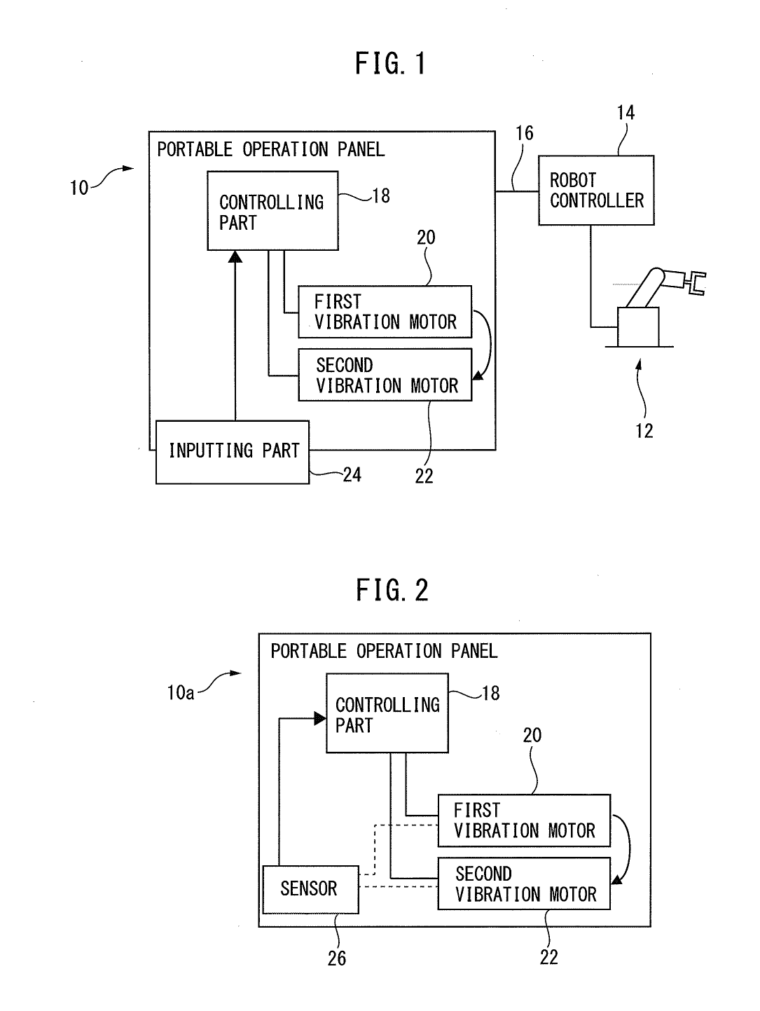

FIG. 1 shows a schematic configuration of a portable operation panel 10 according to a first embodiment of the present invention. Portable operation panel (hereinafter, also referred to as merely “operation panel”) 10 is connected to a robot controller 14 which controls a schematically shown machine or robot 12, via radio waves or a wire such as an electric cable 16. An operator may convey operation panel 10 within a predetermined area from robot controller 14, and may operate or teach the machine or robot 12 by using operation panel 10.

Operation panel 10 has a controlling part 18 which controls general behaviors of operation panel 10; a plurality of (two in the illustrated embodiment) vibration motors 20 and 22; and an inputting part 24, such as a keyboard or touch panel, to which the operator can input information. Controlling part 18 may control the behaviors of operation panel 10 based on the information which is input into inputting part 24. When vibration motors 20 and 22 are operated based on a command from controlling part 18, operation panel 10 at least partially vibrates due to the motion of the vibration motor, whereby the operator tactually feels the vibration. Controlling part 18 may change a manner of the vibration of vibration motors 20 and 22 (for example, the controlling part may determine or change the vibrational intensity; whether the vibration is continuous or intermittent; and a vibration period of time when the motor is intermittently operated). The operator can tactually recognize various information from the vibration, by previously associating the manner of the vibration with a content of information such as an alarm for alerting the operator (for example, a malfunction of the robot, and an access of a person to a forbidden area, etc.).

The major feature of the present invention is to use a plurality of vibration motors and a switching part which switches a vibration motor to be used from a vibration motor in use to another vibration motor. In the first embodiment, controlling part 18 corresponds to the switching part, for example, when the operator inputs information into inputting part 24 for switching the vibration motor while first vibration motor 20 is in use, controlling part 18 switches a vibration motor to be used from first vibration motor 20 to second vibration motor 22. Otherwise, the operator may input information relating to a status of each vibration motor (for example, a malfunction or good), and in this case, controlling part 18 can select or switch the vibration motor to be used based on the status of each vibration motor. By virtue of such a configuration, even when a malfunction or abnormality occurs in the vibration motor in use, a vibration motor to be used can be rapidly changed to another vibration motor. Therefore, the vibrational function of operation panel 10 can be continuously used for a long time, in spite of the fact that the vibration motor has a relatively short life.

FIG. 2 is a view showing a schematic configuration of a portable operation panel 10a according to a second embodiment of the present invention. The second embodiment is different from the first embodiment in that switching of the vibration motor is carried out by means of a sensor, not by the input by the operator. Since the other components of the second embodiment may be the same as the first embodiment, the same reference numerals are added to the corresponding components and a detailed explanation thereof will be omitted.

As shown in FIG. 2, operation panel 10a has a sensor 26 configured to detect a physical quantity (for example, the current, temperature and/or number of rotations) of vibration motors 20 and 22, or detect the vibration of operation panel 10a. Sensor 26 detects the physical quantity of at least the vibration motor in use (for example, first vibration motor 20) at predetermined time intervals. Controlling part 18 judges that abnormality occurs in first vibration motor 20 when the physical quantity of first vibration motor 20 detected by sensor 26 is not within a predetermined threshold range in which the vibration motor is normally operated (for example, the current or temperature is excessively high or the number of rotation is considerably low), and then controlling part 18 automatically switches a vibration motor to be used from first vibration motor 20 to second vibration motor 22.

Otherwise, also when sensor 26 detects non-vibration of operation panel 10a or weakening of the vibration of operation panel 10a during controlling part 18 outputs a signal or command for driving or vibrating first vibration motor 20, controlling part 18 judges that abnormality occurs in first vibration motor 20, and then automatically switches a vibration motor to be used from first vibration motor 20 to second vibration motor 22. By virtue of such a configuration, when the malfunction or abnormality occurs in the vibration motor in use, a vibration motor to be used can be quickly switched to another vibration motor.

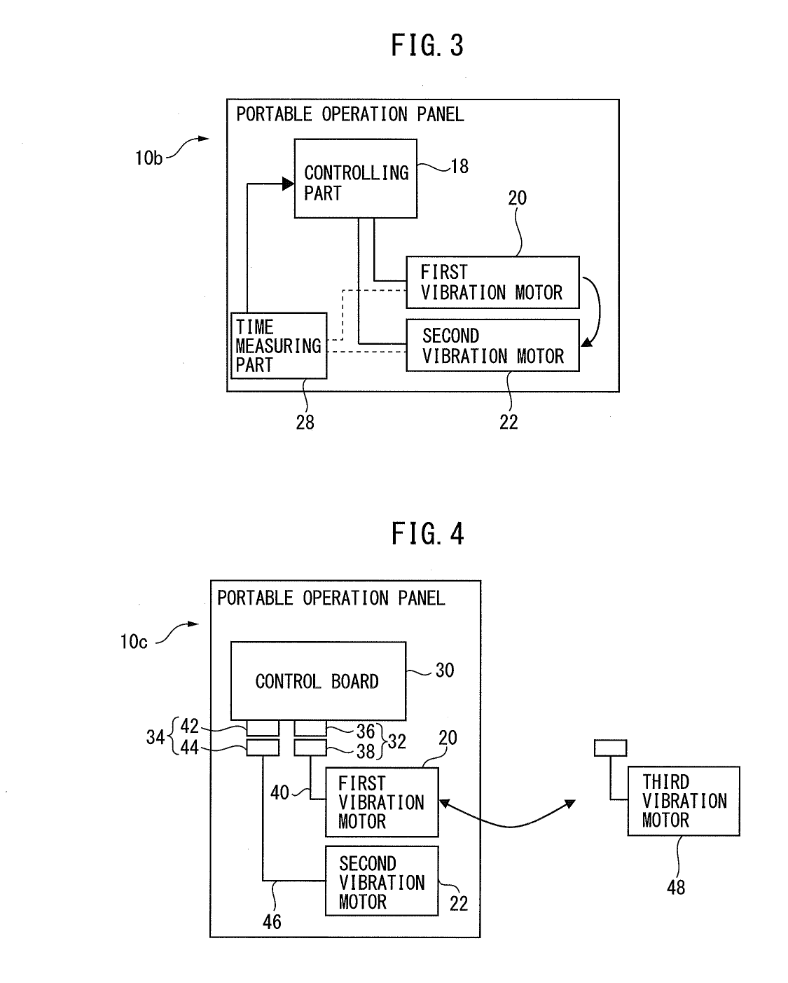

FIG. 3 is a view showing a schematic configuration of a portable operation panel 10b according to a third embodiment of the present invention. The third embodiment is different from the first and second embodiments in that switching of the vibration motor is carried out based on an accumulated operating time of the vibration motor. Since the other components of the third embodiment may be the same as the first and second embodiments, the same reference numerals are added to the corresponding components and a detailed explanation thereof will be omitted.

As shown in FIG. 3, operation panel 10b has a time measuring part 28 such as a timer or a time measuring function which measures an accumulated operating time of each vibration motor. Controlling part 18 automatically switches a vibration motor to be used from first vibration motor 20 to second vibration motor 22, when the accumulated operating time of the vibration motor in use (for example, first vibration motor) exceeds a time limit of use, providing an indication of a life of the vibration motor. In FIG. 3, time measuring part 28 is described as a component separated from controlling part 18, whereas time measuring part 28 may be a portion of controlling part 18. By virtue of such a configuration, a vibration motor to be used can be rapidly switched to another vibration motor at an appropriate time, before the end of the vibration motor's life.

FIG. 4 exemplifies an application of a portable operation panel of the invention, wherein a detachable connector is provided to the portable operation panel so that at least one vibration motor is detachable to the operation panel. Portable operation panel 10c incorporates a control board 30 which substantially corresponds to controlling part 18 as described above. Connectors 32 and 34 are provided to control board 30 so that vibration motors 20 and 22 are detachably connected to control board 30, respectively. For example, first connector 32 has a first receptacle 36 arranged on control board 30 and a first plug 38 detachably connected to first receptacle 36, and first plug 38 is connected to first vibration motor 20 via a first cable 40, etc. Similarly, second connector 34 has a second receptacle 42 arranged on control board 30 and a second plug 44 detachably connected to second receptacle 42, and second plug 44 is connected to second vibration motor 22 via a second cable 46, etc. By virtue of such a connector configuration, the vibration motor connected to control board 30 can be easily detached, and another vibration motor (for example, a third vibration motor 48) can be connected to control board 30 instead. In addition, when the connector is provided to the operation panel as shown in FIG. 4, the means in any of the first, second and third embodiments may be used as switching means for the vibration motor of the operation panel.

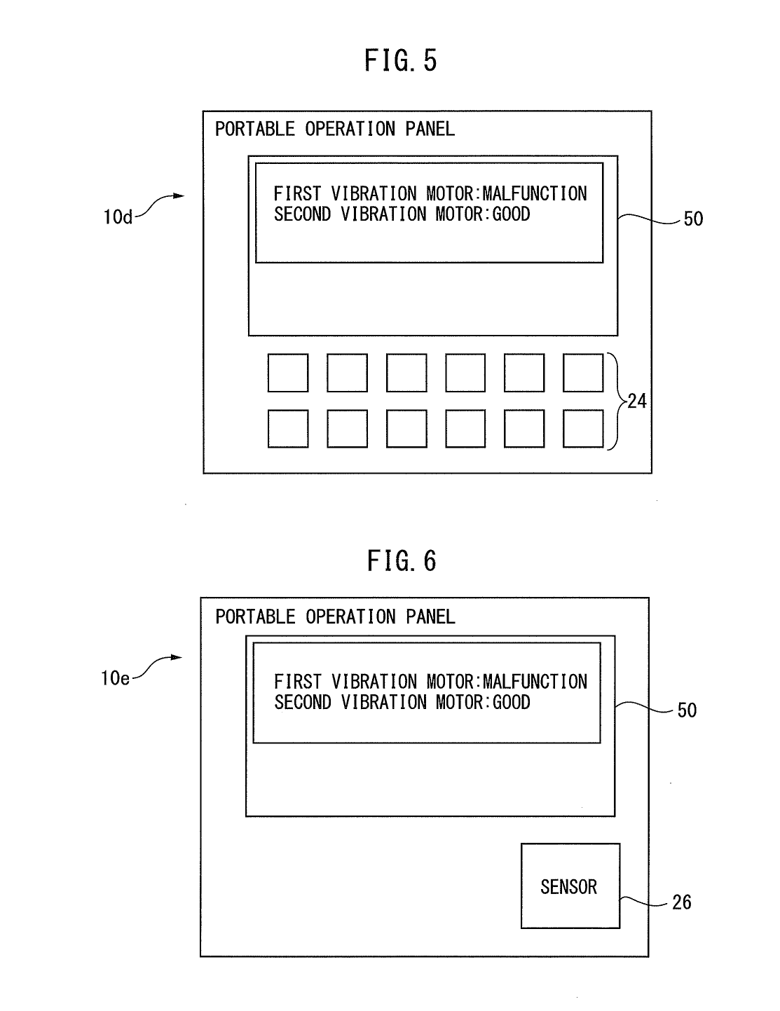

FIGS. 5 to 7 exemplify other applications of a portable operation panel of the invention, wherein a displaying part is provided to the portable operation panel. Portable operation panel 10d has a displaying part 50 such as a monitor, and displaying part 50 can display information regarding the vibration motor. For example, as in the first embodiment of FIG. 1, when operation panel 10d has inputting part 24 to which the operator can input the status of each vibration motor, displaying part 50 can display information regarding the status of each vibration motor input by the operator, as shown in FIG. 5.

Alternatively, as shown in FIG. 6, when a portable operation panel 10e has sensor 26 as in the second embodiment of FIG. 2, displaying part 50 of FIG. 6 can display a detection result of sensor 26, or, information regarding the status of each vibration motor (malfunction or good, etc.), wherein the status is judged by the controlling part based on the detection result.

In the embodiment of FIG. 6, inputting part 24 as shown in FIG. 1 or 5 may be further arranged. In this case, the operator can recognize the status of each vibration motor by means of displaying part 50, and can switch the vibration motor by using inputting part 24 if the operator judges that the vibration motor should be switched based on the displayed status.

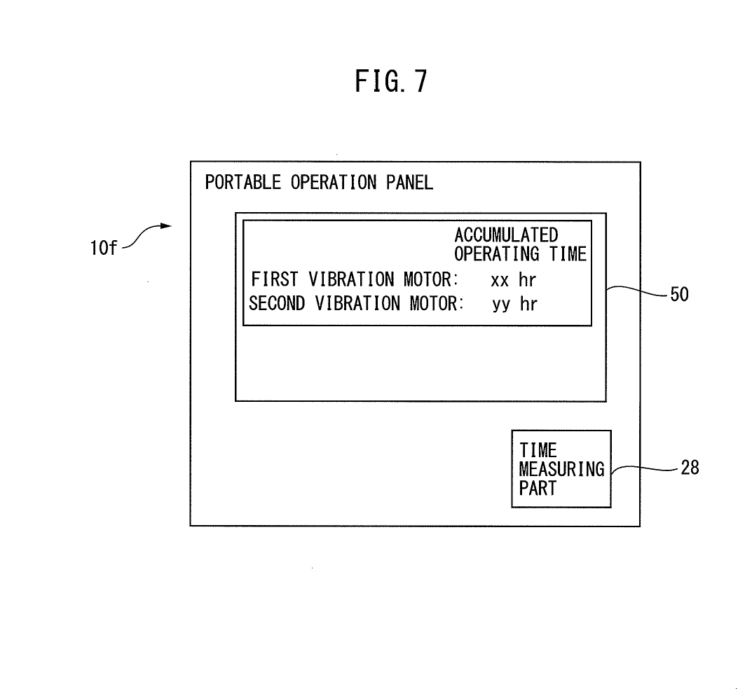

Alternatively, as shown in FIG. 7, when a portable operation panel 10f has time measuring part 28 as in the third embodiment of FIG. 3, displaying part 50 of FIG. 7 can display the accumulated operating time of each vibration motor measured by time measuring part 28. By providing the displaying part to the operation panel as described above, the operator can easily and visually check the status of each vibration motor.

In the embodiment of FIG. 7, inputting part 24 as shown in FIG. 1 or 5 may be further arranged. In this case, the operator can recognize the accumulated operating time of each vibration motor by means of displaying part 50, and can switch the vibration motor by using inputting part 24 if the operator judges that the vibration motor should be switched based on the displayed accumulated operating time.

Although the preferred embodiments are described above, the present invention is not limited as such. For example, three or more vibration motors may be provided to the portable operation panel. Two or all of the inputting part, the sensor and the time measuring part may be provided to the operation panel, and a priority order may be predetermined regarding the switching of the vibration motor. Further, a plurality of vibration motors may be connected to one connector, and/or only one connector may be provided to the operation panel. The operation panel may be provided with both the connector and the displaying part. In addition, although the switching of the vibration motor may be carried out by the controlling part of the operation panel as described above, another switching means may be arranged separately.

According to the present invention, the loss of the vibration function of the portable operation panel in use can be prevented, unless all of the plurality of vibration motors provided to the operation panel simultaneously get out of order.

According to the present invention, since the plurality of vibration motors can be properly switched from one to the other, the vibrational function of the portable operation panel can be continuously used for many hours, whereby work efficiency thereof is improved.

The switching operation of the vibration motor can be carried out by using, for example, the inputting part to which the operator can input information, the sensor for detecting abnormality, etc., of the vibration motor, or the time measuring part for measuring the accumulated operating time of the vibration motor. In any of the cases, a special device is not necessary. Further, when the sensor or the time measuring part is used, the switching of the vibration motor can be carried out automatically.

By providing the connector to the control board of the portable operation panel so that at least one of the vibration motor is detachably connected to the operation panel, the vibration motor having a malfunction can be rapidly replaced with a new vibration motor.

By providing the displaying part to the portable operation panel, the operator easily recognize information, e.g., whether each vibration motor is usable or unusable, or a remnant life of each vibration motor, etc.

While the invention has been described with reference to specific embodiments chosen for the purpose of illustration, it should be apparent that numerous modifications could be made thereto, by one skilled in the art, without departing from the basic concept and scope of the invention.

1. A portable operation panel connected to a controller for controlling a machine so that the portable operation panel is used to operate the machine, the portable operation panel comprising:
a plurality of vibration motors which generate vibration for providing predetermined information to an operator; and
a switching part which switches a motor to be used from a first vibration motor of the plurality of vibration motors to a second vibration motor of the plurality of vibration motors.

2. The portable operation panel as set forth in claim 1, comprising an inputting part to which the operator can input information,
wherein the switching part switches the motor to be used from the first vibration motor to the second vibration motor based on the information which is input to the inputting part.

3. The portable operation panel as set forth in claim 1, comprising a sensor which detects a malfunction of the vibration motor, non-vibration of the portable operation panel or weakening of the vibration of the portable operation panel,
wherein the switching part automatically switches the motor to be used from the first vibration motor to the second vibration motor when the sensor detects the malfunction of the vibration motor, the non-vibration of the portable operation panel or the weakening of the vibration of the portable operation panel.

4. The portable operation panel as set forth in claim 1, comprising a time measuring part which measures an accumulated operating time of the vibration motor,
wherein the switching part automatically switches the motor to be used from the first vibration motor to the second vibration motor when the accumulated operating time of the vibration motor during use reaches a predetermined time limit of use.

5. The portable operation panel as set forth in claim 1, comprising a connector arranged on a control board incorporated into the portable operation panel, wherein at least one of the plurality of vibration motors is detachably connected to the connector.

6. The portable operation panel as set forth in claim 2, further comprising a displaying part which displays the information which is input to the inputting part.

7. The portable operation panel as set forth in claim 3, further comprising a displaying part which displays a detection result of the sensor or information obtained by the detection result.

8. The portable operation panel as set forth in claim 4, further comprising a displaying part which displays the accumulated operating time of each vibration motor measured by the time measuring part.

9. The portable operation panel as set forth in claim 2, further comprising:
a sensor which detects a malfunction of the vibration motor, non-vibration of the portable operation panel or weakening of the vibration of the portable operation panel; and
a displaying part which displays a detection result of the sensor or information obtained by the detection result.

10. The portable operation panel as set forth in claim 2, further comprising:
a time measuring part which measures an accumulated operating time of the vibration motor; and
a displaying part which displays the accumulated operating time of each vibration motor measured by the time measuring part.
